(19) United States
(12) Patent Application Publication
(10) Pub. No.: US 2026/0173070 A1
(43) Pub. Date: Jun. 18, 2026

(54) MULTIPLEXING OF SMALL DATA TRANSMISSIONS

(71) Applicant: QUALCOMM Incorporated, San Diego, CA (US)

(72) Inventors: Jing LEI, San Diego, CA (US); Weimin DUAN, San Diego, CA (US); Kangqi LIU, San Diego, CA (US)

(21) Appl. No.: 18/986,499

(22) Filed: Dec. 18, 2024

(51) Int. Cl. H04W 72/1263; H04L 5/02

(52) U.S. Cl. CPC H04W 72/1263; H04L 5/023

(57) ABSTRACT

Methods, systems, and devices for wireless communications are described. A user equipment (UE) may encode a first small data transmission (SDT) associated with a first service according to a first set of multiple access parameters and encode a second SDT associated with a second service according to a second set of multiple access parameters. Each of the first SDT and the second SDT may include a respective amount of data less than a threshold amount of data associated with SDTs. The UE may transmit, via a first set of communication resources, the first SDT associated with the first service based on the first set of multiple access parameters. The UE may further transmit, via the first set of communication resources, the second SDT associated with the second service based on the second set of multiple access parameters.

### TECHNICAL FIELD

The following relates generally to wireless communications, and more specifically to multiplexing of small data transmissions (SDTs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The systems, methods, and devices of this disclosure each have several innovative aspects, no single one of which is solely responsible for the desirable attributes disclosed herein.

A method for wireless communications by a user equipment (UE) is described. The method may include encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs, transmitting, via a first set of communication resources, the first SDT associated with the first service based on the first set of multiple access parameters, and transmitting, via the first set of communication resources, the second SDT associated with the second service based on the second set of multiple access parameters.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to encode a first SDT associated with a first service according to a first set of multiple access parameters and a second SDT associated with a second service according to a second set of multiple access parameters, each of the first SDT and the second SDT including a respective amount of data less than a threshold amount of data associated with SDTs, transmit, via a first set of communication resources, the first SDT associated with the first service based on the first set of multiple access parameters, and transmit, via the first set of communication resources, the second SDT associated with the second service based on the second set of multiple access parameters.

Another UE for wireless communications is described. The UE may include means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs, means for transmitting, via a first set of communication resources, the first SDT associated with the first service based on the first set of multiple access parameters, and means for transmitting, via the first set of communication resources, the second SDT associated with the second service based on the second set of multiple access parameters.

A non-transitory computer-readable medium storing code for wireless communications is described. The code may include instructions executable by one or more processors (e.g., directly, indirectly, after pre-processing, without pre-processing) to encode a first SDT associated with a first service according to a first set of multiple access parameters and a second SDT associated with a second service according to a second set of multiple access parameters, each of the first SDT and the second SDT including a respective amount of data less than a threshold amount of data associated with SDTs, transmit, via a first set of communication resources, the first SDT associated with the first service based on the first set of multiple access parameters, and transmit, via the first set of communication resources, the second SDT associated with the second service based on the second set of multiple access parameters.

In some examples of the method, UEs, and non-transitory computer-readable medium described herein, the first SDT may be associated with a first radio unit corresponding to the first service and the second SDT may be associated with a second radio unit corresponding to the second service.

In some examples of the method, UEs, and non-transitory computer-readable medium described herein, both the first SDT and the second SDT may be associated with a first radio unit shared between the first service and the second service.

In some examples of the method, UEs, and non-transitory computer-readable medium described herein, transmitting the first SDT and transmitting the second SDT may include operations, features, means, or instructions for transmitting the first SDT with a first transmit power via the first set of communication resources, the first transmit power associated with the first service and transmitting the second SDT with a second transmit power via the first set of communication resources, the second transmit power associated with the second service.

In some examples of the method, UEs, and non-transitory computer-readable medium described herein, the first SDT may be encoded using an in-phase portion of a first signal that may be modulated according to orthogonal frequency division multiplexing, the second SDT may be encoded using a quadrature phase portion of the first signal, and the first service may be associated with the in-phase portion of the first signal and the second service may be associated with the quadrature phase portion of the first signal.

In some examples of the method, UEs, and non-transitory computer-readable medium described herein, the first SDT may be encoded in accordance with a first spreading factor, a first spreading sequence, or a first scrambling sequence associated with the first service and the second SDT may be encoded in accordance with a second spreading factor, a second spreading sequence, or a second scrambling sequence associated with the second service.

In some examples of the method, UEs, and non-transitory computer-readable medium described herein, the first SDT may be encoded via a first subset of symbols of a first signal and the second SDT may be encoded via a second subset of symbols of the first signal and the first subset of symbols associated with the first service and the second subset of symbols associated with the second service may be interleaved within the first signal.

Some examples of the method, UEs, and non-transitory computer-readable medium described herein may further include operations, features, means, or instructions for transmitting signaling indicative of assistance information associated with multiple access SDTs, the assistance information indicating the first set of multiple access parameters associated with the first service, the second set of multiple access parameters associated with the second service, or both.

In some examples of the method, UEs, and non-transitory computer-readable medium described herein, the signaling indicative of the assistance information includes radio resource control (RRC) signaling, medium access control control element (MAC-CE) signaling, uplink control information (UCI) signaling, or a combination thereof.

In some examples of the method, UEs, and non-transitory computer-readable medium described herein, the first service may be associated with a first radio access network technology (RAT), a first network operator, or both and the second service may be associated with a second RAT, a second network operator, or both.

A method for wireless communications by a UE is described. The method may include receiving, via a first set of communication resources, a first SDT associated with a first service, receiving, via the first set of communication resources, a second SDT associated with a second service, each of the first SDT and the second SDT including a respective amount of data less than a threshold amount of data associated with SDTs, and selectively decoding one of the first SDT or the second SDT.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive, via a first set of communication resources, a first SDT associated with a first service, receive, via the first set of communication resources, a second SDT associated with a second service, each of the first SDT and the second SDT including a respective amount of data less than a threshold amount of data associated with SDTs, and selectively decode one of the first SDT or the second SDT.

Another UE for wireless communications is described. The UE may include means for receiving, via a first set of communication resources, a first SDT associated with a first service, means for receiving, via the first set of communication resources, a second SDT associated with a second service, each of the first SDT and the second SDT including a respective amount of data less than a threshold amount of data associated with SDTs, and means for selectively decoding one of the first SDT or the second SDT.

A non-transitory computer-readable medium storing code for wireless communications is described. The code may include instructions executable by one or more processors (e.g., directly, indirectly, after pre-processing, without pre-processing) to receive, via a first set of communication resources, a first SDT associated with a first service, receive, via the first set of communication resources, a second SDT associated with a second service, each of the first SDT and the second SDT including a respective amount of data less than a threshold amount of data associated with SDTs, and selectively decode one of the first SDT or the second SDT.

In some examples of the method, UEs, and non-transitory computer-readable medium described herein, selectively decoding one of the first SDT or the second SDT may include operations, features, means, or instructions for performing an interference cancellation procedure to cancel interference associated with one of the first SDT or the second SDT.

In some examples of the method, UEs, and non-transitory computer-readable medium described herein, both the first SDT and the second SDT may be associated with a first radio unit shared between the first service and the second service.

In some examples of the method, UEs, and non-transitory computer-readable medium described herein, receiving the first SDT and receiving the second SDT may include operations, features, means, or instructions for receiving the first SDT in accordance with a first transmit power via the first set of communication resources, the first transmit power associated with the first service and receiving the second SDT in accordance with a second transmit power via the first set of communication resources, the second transmit power associated with the second service, where selectively decoding one of the first SDT or the second SDT may be based on the first transmit power, the second transmit power, or both.

In some examples of the method, UEs, and non-transitory computer-readable medium described herein, the first service may be associated with an in-phase portion of a first signal that may be modulated according to orthogonal frequency division multiplexing and the second service may be associated with a quadrature phase portion of the first signal and selectively decoding one of the first SDT or the second SDT includes selectively decoding the in-phase portion of the first signal or the quadrature phase portion of the first signal.

In some examples of the method, UEs, and non-transitory computer-readable medium described herein, selectively decoding one of the first SDT or the second SDT may be based on a first spreading factor, a first spreading sequence, or a first scrambling sequence associated with the first service, a second spreading factor, a second spreading sequence, or a second scrambling sequence associated with the second service, or a combination thereof.

In some examples of the method, UEs, and non-transitory computer-readable medium described herein, the first SDT may be received via a first subset of symbols of a first signal and the second SDT may be received via a second subset of symbols of the first signal, the first subset of symbols associated with the first service and the second subset of symbols associated with the second service may be interleaved within the first signal, and selectively decoding one of the first SDT or the second SDT includes selectively decoding the first subset of symbols of the first signal or the second subset of symbols of the first signal.

Some examples of the method, UEs, and non-transitory computer-readable medium described herein may further include operations, features, means, or instructions for receiving signaling indicative of assistance information associated with multiple access SDTs, the assistance information indicating a first set of multiple access parameters associated with the first service, a second set of multiple access parameters associated with the second service, or both, where selectively decoding one of the first SDT or the second SDT may be based on the assistance information.

In some examples of the method, UEs, and non-transitory computer-readable medium described herein, the signaling indicative of the assistance information includes RRC signaling, MAC-CE signaling, downlink control information (DCI) signaling, or a combination thereof.

In some examples of the method, UEs, and non-transitory computer-readable medium described herein, the first service may be associated with a first RAT, a first network operator, or both and the second service may be associated with a second RAT, a second network operator, or both.

A method for wireless communications by a network entity is described. The method may include encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs, transmitting, via a first set of communication resources, the first SDT associated with the first service based on the first set of multiple access parameters, and transmitting, via the first set of communication resources, the second SDT associated with the second service based on the second set of multiple access parameters.

A network entity for wireless communications is described. The network entity may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the network entity to encode a first SDT associated with a first service according to a first set of multiple access parameters and a second SDT associated with a second service according to a second set of multiple access parameters, each of the first SDT and the second SDT including a respective amount of data less than a threshold amount of data associated with SDTs, transmit, via a first set of communication resources, the first SDT associated with the first service based on the first set of multiple access parameters, and transmit, via the first set of communication resources, the second SDT associated with the second service based on the second set of multiple access parameters.

Another network entity for wireless communications is described. The network entity may include means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs, means for transmitting, via a first set of communication resources, the first SDT associated with the first service based on the first set of multiple access parameters, and means for transmitting, via the first set of communication resources, the second SDT associated with the second service based on the second set of multiple access parameters.

A non-transitory computer-readable medium storing code for wireless communications is described. The code may include instructions executable by one or more processors (e.g., directly, indirectly, after pre-processing, without pre-processing) to encode a first SDT associated with a first service according to a first set of multiple access parameters and a second SDT associated with a second service according to a second set of multiple access parameters, each of the first SDT and the second SDT including a respective amount of data less than a threshold amount of data associated with SDTs, transmit, via a first set of communication resources, the first SDT associated with the first service based on the first set of multiple access parameters, and transmit, via the first set of communication resources, the second SDT associated with the second service based on the second set of multiple access parameters.

In some examples of the method, network entities, and non-transitory computer-readable medium described herein, the first SDT may be associated with a first radio unit corresponding to the first service and the second SDT may be associated with a second radio unit corresponding to the second service.

In some examples of the method, network entities, and non-transitory computer-readable medium described herein, both the first SDT and the second SDT may be associated with a first radio unit shared between the first service and the second service of the network entity.

In some examples of the method, network entities, and non-transitory computer-readable medium described herein, transmitting the first SDT and transmitting the second SDT may include operations, features, means, or instructions for transmitting the first SDT with a first transmit power via the first set of communication resources, the first transmit power associated with the first service and transmitting the second SDT with a second transmit power via the first set of communication resources, the second transmit power associated with the second service.

In some examples of the method, network entities, and non-transitory computer-readable medium described herein, the first SDT may be encoded using an in-phase portion of a first signal that may be modulated according to orthogonal frequency division multiplexing, the second SDT may be encoded using a quadrature phase portion of the first signal, and the first service may be associated with the in-phase portion of the first signal and the second service may be associated with the quadrature phase portion of the first signal.

In some examples of the method, network entities, and non-transitory computer-readable medium described herein, the first SDT may be encoded in accordance with a first spreading factor, a first spreading sequence, or a first scrambling sequence associated with the first service and the second SDT may be encoded in accordance with a second spreading factor, a second spreading sequence, or a second scrambling sequence associated with the second service.

In some examples of the method, network entities, and non-transitory computer-readable medium described herein, the first SDT may be encoded via a first subset of symbols of a first signal and the second SDT may be encoded via a second subset of symbols of the first signal and the first subset of symbols associated with the first service and the second subset of symbols associated with the second service may be interleaved within the first signal.

Some examples of the method, network entities, and non-transitory computer-readable medium described herein may further include operations, features, means, or instructions for transmitting signaling indicative of assistance information associated with multiple access SDTs, the assistance information indicating the first set of multiple access parameters associated with the first service, the second set of multiple access parameters associated with the second service, or both.

In some examples of the method, network entities, and non-transitory computer-readable medium described herein, the signaling indicative of the assistance information includes RRC signaling, MAC-CE signaling, DCI signaling, or a combination thereof.

In some examples of the method, network entities, and non-transitory computer-readable medium described herein, the first service may be associated with a first RAT, a first network operator, or both and the second service may be associated with a second RAT, a second network operator, or both.

A method for wireless communications by a network entity is described. The method may include receiving, via a first set of communication resources, a first SDT associated with a first service, receiving, via the first set of communication resources, a second SDT associated with a second service, each of the first SDT and the second SDT including a respective amount of data less than a threshold amount of data associated with SDTs, and selectively decoding one of the first SDT or the second SDT.

A network entity for wireless communications is described. The network entity may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the network entity to receive, via a first set of communication resources, a first SDT associated with a first service, receive, via the first set of communication resources, a second SDT associated with a second service, each of the first SDT and the second SDT including a respective amount of data less than a threshold amount of data associated with SDTs, and selectively decode one of the first SDT or the second SDT.

Another network entity for wireless communications is described. The network entity may include means for receiving, via a first set of communication resources, a first SDT associated with a first service, means for receiving, via the first set of communication resources, a second SDT associated with a second service, each of the first SDT and the second SDT including a respective amount of data less than a threshold amount of data associated with SDTs, and means for selectively decoding one of the first SDT or the second SDT.

A non-transitory computer-readable medium storing code for wireless communications is described. The code may include instructions executable by one or more processors (e.g., directly, indirectly, after pre-processing, without pre-processing) to receive, via a first set of communication resources, a first SDT associated with a first service, receive, via the first set of communication resources, a second SDT associated with a second service, each of the first SDT and the second SDT including a respective amount of data less than a threshold amount of data associated with SDTs, and selectively decode one of the first SDT or the second SDT.

In some examples of the method, network entities, and non-transitory computer-readable medium described herein, selectively decoding one of the first SDT or the second SDT may include operations, features, means, or instructions for performing an interference cancellation procedure to cancel interference associated with one of the first SDT or the second SDT.

In some examples of the method, network entities, and non-transitory computer-readable medium described herein, both the first SDT and the second SDT may be associated with a first radio unit shared between the first service and the second service.

In some examples of the method, network entities, and non-transitory computer-readable medium described herein, receiving the first SDT and receiving the second SDT may include operations, features, means, or instructions for receiving the first SDT in accordance with a first transmit power via the first set of communication resources, the first transmit power associated with the first service and receiving the second SDT in accordance with a second transmit power via the first set of communication resources, the second transmit power associated with the second service, where selectively decoding one of the first SDT or the second SDT may be based on the first transmit power, the second transmit power, or both.

In some examples of the method, network entities, and non-transitory computer-readable medium described herein, the first service may be associated with an in-phase portion of a first signal that may be modulated according to orthogonal frequency division multiplexing and the second service may be associated with a quadrature phase portion of the first signal and selectively decoding one of the first SDT or the second SDT includes selectively decoding the in-phase portion of the first signal or the quadrature phase portion of the first signal.

In some examples of the method, network entities, and non-transitory computer-readable medium described herein, selectively decoding one of the first SDT or the second SDT may be based on a first spreading factor, a first spreading sequence, or a first scrambling sequence associated with the first service, a second spreading factor, a second spreading sequence, or a second scrambling sequence associated with the second service, or a combination thereof.

In some examples of the method, network entities, and non-transitory computer-readable medium described herein, the first SDT may be received via a first subset of symbols of a first signal and the second SDT may be received via a second subset of symbols of the first signal, the first subset of symbols associated with the first service and the second subset of symbols associated with the second service may be interleaved within the first signal, and selectively decoding one of the first SDT or the second SDT includes selectively decoding the first subset of symbols of the first signal or the second subset of symbols of the first signal.

Some examples of the method, network entities, and non-transitory computer-readable medium described herein may further include operations, features, means, or instructions for receiving signaling indicative of assistance information associated with multiple access SDTs, the assistance information indicating a first set of multiple access parameters associated with the first service, a second set of multiple access parameters associated with the second service, or both, where selectively decoding one of the first SDT or the second SDT may be based on the assistance information.

In some examples of the method, network entities, and non-transitory computer-readable medium described herein, the signaling indicative of the assistance information includes RRC signaling, MAC-CE signaling, UCI signaling, or a combination thereof.

In some examples of the method, network entities, and non-transitory computer-readable medium described herein, the first service may be associated with a first RAT, a first network operator, or both and the second service may be associated with a second RAT, a second network operator, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports multiplexing of small data transmissions (SDTs) in accordance with one or more aspects of the present disclosure.

FIG. 2 shows an example of a wireless communications system that supports multiplexing of SDTs in accordance with one or more aspects of the present disclosure.

FIGS. 3A and 3B show examples of wireless communications systems that support multiplexing of SDTs in accordance with one or more aspects of the present disclosure.

FIG. 4 shows an example of a wireless communications system that supports multiplexing of SDTs in accordance with one or more aspects of the present disclosure.

FIGS. 5A-5D show examples of multiplexing schemes that support multiplexing of SDTs in accordance with one or more aspects of the present disclosure.

FIGS. 6 and 7 show block diagrams of devices that support multiplexing of SDTs in accordance with one or more aspects of the present disclosure.

FIG. 8 shows a block diagram of a communications manager that supports multiplexing of SDTs in accordance with one or more aspects of the present disclosure.

FIG. 9 shows a diagram of a system including a device that supports multiplexing of SDTs in accordance with one or more aspects of the present disclosure.

FIGS. 10 and 11 show block diagrams of devices that support multiplexing of SDTs in accordance with one or more aspects of the present disclosure.

FIG. 12 shows a block diagram of a communications manager that supports multiplexing of SDTs in accordance with one or more aspects of the present disclosure.

FIG. 13 shows a diagram of a system including a device that supports multiplexing of SDTs in accordance with one or more aspects of the present disclosure.

FIGS. 14 and 15 show flowcharts illustrating methods that support multiplexing of SDTs in accordance with one or more aspects of the present disclosure.

### DETAILED DESCRIPTION

In some wireless communications systems, a user equipment (UE) and a network entity may communicate small data transmissions (SDTs). SDTs may allow signaling of data while the UE remains in an inactive state (e.g., a radio resource control (RRC) inactive state). In some cases, SDTs may be initiated by the UE or by the network entity if less than a threshold amount of data (e.g., a configured threshold) awaits transmission at the UE or is scheduled for transmission to the UE. In some cases, it may be beneficial to support SDTs on a shared spectrum that is shared between different network operators and/or different radio access network technologies (RATs), to support scheduling flexibility and more efficient utilization of communication resources. However, further enhancements may be needed to support multiplexing of SDTs for different operators or RATs on a shared spectrum.

According to examples described herein, the UE or the network entity, or both, may support multiplexing of SDTs on shared communication resources (e.g., time and/or frequency resources) for simultaneous communication of multiple SDTs that are associated with different operators or RATs. For example, the UE may transmit a first SDT for a first operator or RAT on a first set of communication resources and may transmit a second SDT for a second operator or RAT on the same first set of communication resources. The UE may differentiate the first SDT and the second SDT using transmit power offsets, scrambling or spreading sequences, orthogonal multiplexing, or interleaving patterns, among other techniques. In some implementations, the UE may transmit assistance information that assists the network in decoding the multiple SDTs transmitted on shared spectrum. The assistance information may indicate a modulation scheme used to encode each of the first SDT and the second SDT. In some examples, similar techniques may be implemented by a network entity to support multiplexing of downlink SDTs on shared communication resources. These and other techniques are described in further detail with respect to the figures.

Aspects of the disclosure are initially described in the context of wireless communications systems. Aspects of the disclosure are further described in the context of wireless communication systems and multiplexing schemes. Aspects of the disclosure are further illustrated by and described with reference to apparatus diagrams, system diagrams, and flowcharts that relate to multiplexing of SDTs.

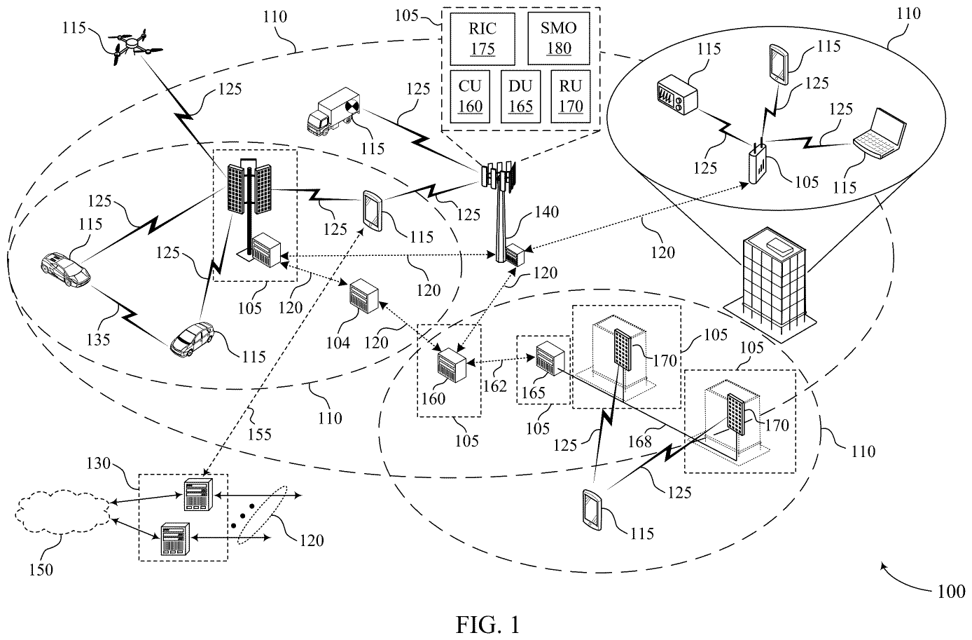

FIG. 1 shows an example of a wireless communications system 100 that supports multiplexing of SDTs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support multiplexing of SDTs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the network entities 105 or the UEs 115 may be

expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UE 115, the network entity 105, or both may support SDT. SDT may allow data and/or signaling transmission while the UE 115 or the network entity 105 remains in an RRC inactive state (e.g., without transitioning to an RRC connected state). An SDT procedure may be initiated if less than a configured amount of data awaits transmission. That is, a SDT is a transmission with an amount of data that is less than a threshold associated with small data transmissions. If the data of a transmission is greater than the SDT threshold, the normal data transmission scheme may be used. During the SDT procedure, the UE 115 may monitor control channels associated with a shared data channel to determine if data is scheduled for itself. In some cases, the UE 115 may achieve power savings (e.g., a 30% mA savings) by performing SDTs in the RRC inactive state.

In some wireless communications systems 100, a UE 115 and a network entity 105 may communicate SDTs. SDTs may allow signaling of data while the UE 115 remains in an inactive state (e.g., a RRC inactive state). In some cases, SDTs may be initiated by the UE 115 or by the network entity 105 if less than a threshold amount of data (e.g., a configured threshold) awaits transmission at the UE 115 or is scheduled for transmission to the UE 115. In some cases, it may be beneficial to support SDTs on a shared spectrum that is shared between different network operators and/or different RATs, to support scheduling flexibility and more efficient utilization of communication resources. However, further enhancements may support multiplexing of SDTs for different operators or RATs on a shared spectrum.

According to examples described herein, the UE 115 or the network entity 105, or both, may support multiplexing of SDTs on shared communication resources (e.g., time or frequency resources) for simultaneous communication of multiple SDTs that are associated with different operators or RATs. For example, the UE 115 may transmit a first SDT for a first operator or RAT on a first set of communication resources and may transmit a second SDT for a second operator or RAT on the same first set of communication resources. The UE 115 may differentiate the first SDT and the second SDT using transmit power offsets, scrambling or spreading sequences, orthogonal multiplexing, or interleaving patterns, among other techniques. In some implementations, the UE 115 may transmit assistance information that assists the network in decoding the multiple SDTs transmitted on shared spectrum. The assistance information may indicate a modulation scheme used to encode each of the first SDT and the second SDT. In some examples, similar techniques may be implemented by a network entity 105 to support multiplexing of downlink SDTs on shared communication resources. The techniques described herein may be implemented when two transmissions are less than one or more configured thresholds associated with SDT. For example, a UE 115 may determine that a two transmissions buffered for different RATs, operators, or services may be less than one or more thresholds associated with SDTs, and then use the multiplexing techniques described herein to transmit the two transmissions.

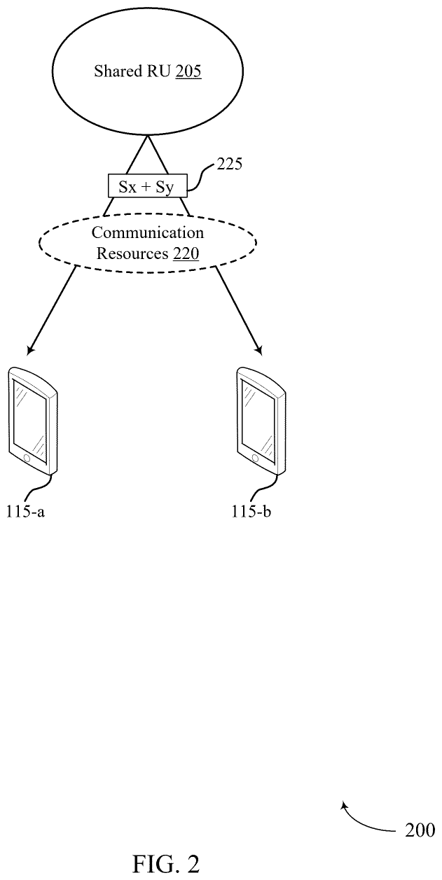

FIG. 2 shows an example of a wireless communications system 200 that supports multiplexing of SDTs in accordance with one or more aspects of the present disclosure. The wireless communications system 200 may implement or may be implemented by aspects of the wireless communications system 100. For example, the wireless communications system 200 may include a UE 115-a and a UE 115-b, which may be examples of the UE 115 as described with reference to FIG. 1. The wireless communications system 200 may include an RU 205 which may be implemented by one or more network entities 105 (e.g., the RU is shared between two or more RATs, two or more operators), as described with reference to FIG. 1.

A UE 115 and a network (e.g., one or more RUs 205) may support SDTs, which may be advantageous both for the UEs 115 (e.g., power saving) and the network (e.g., overhead reduction, network emulation solutions). In some cases, new spectrum with sufficient (e.g., relatively high quality) coverage may not be available everywhere for SDT deployment. In such cases, the UEs 115 and the network may implement low-complexity designs facilitating holistic energy and power savings for the UEs 115 and the network. For example, the UEs 115 and the network may implement RAN or spectrum sharing for different operators or different RATs, which may support reduced costs (e.g., capital expenditures (COPEX), operational expenditures (OPEX)) of implementation for the wireless communications system 200. In some cases, the UE 115 and the network may utilize non-orthogonal multiple access (NOMA) techniques and/or mobile-originated (MO) and mobile-terminated (MT) SDTs, but such techniques may be limited to single cell operations.

In accordance with examples described herein, enhancements to SDT may enable communication (e.g., uplink communication, downlink communication) of SDTs for multiple cells or RATs via communication resources 220 (e.g., shared communication resources) to enable co-existence of different operators, RATs, or services in the wireless communications system 200. The SDTs being communicated to or from the multiple operators, RATs, or services may support orthogonal multiplexing access (OMA) schemes or NOMA schemes. The UEs 115 may have various statuses of subscriptions (e.g., multiple UEs 115 performing SDT on the communication resources 220 shared by different operators or different RATs, SDT for multi-RAT spectrum sharing, a multi-subscriber identity module (SIM) UE 115, such as a UE 115 with multiple SIM cards, performing SDT transmission/reception with cells belonging to different operators/RATs, among other examples).

In some implementations, the SDTs may be communicated via a reduced bandwidth (e.g., initial bandwidth part) and may include rank-1 physical downlink shared channel (PDSCH) or physical uplink shared channel (PUSCH) transmissions. Though the examples are described herein as being applicable to the UE 115 or a network entity in an inactive state (e.g., RRC inactive state), the examples described herein may be extended to a UE 115 or a network entity operating in a connected state (e.g., RRC connected state). For example, the described techniques may be implemented based on a determination that the data volume of SDT is below pre-configured thresholds and that the link qualities are above pre-configured thresholds. In some implementations, thresholds for data volume of SDT may be jointly or separately configured for different RATs or operators. One or more rules may be predefined or indicated by the network to segment the SDT packets from a control plane or a user plane. To support coverage or reliability thresholds, one or more repetitions of the SDTs may be supported on downlink or uplink for orthogonal or non-orthogonal division multiplexing.

In the example of the wireless communications system 200, the RU 205 may transmit a multiplexed transmission 225 via the communication resources 220 (e.g., time/frequency resources) that includes multiple SDTs (e.g., SDT packets). For example, the multiplexed transmission 225 may include a first SDT, Sₓ (e.g., a first SDT packet) of a first RAT or operator or service, and a second SDT, S_{y} (e.g., a second SDT packet) of a second RAT or operator or service. Accordingly, SDT packets from different RATs or operators which share the RU 205 may share the same communication resources 220 on downlink. The multiplexed transmission 225 may be unicast, multicast, or broadcast type. In a first implementation, the UE 115-a may receive Sₓ of a first RAT (e.g., a

legacy RAT). The UE 115-b may receive S_{y} of a second RAT (e.g., a non-legacy RAT). The UE 115-a may treat S_{y} as noise/interference. In some implementations, the UE 115-b may fully or partially cancel Sₓ before decoding S_{y}. The UE 115-b may fully or partially cancel Sₓ using prior information of Sₓ indicated by the network (e.g., the RU 205).

In a second implementation, the UE 115-a may receive Sₓ of a first operator. The UE 115-b may receive S_{y} of a second operator. In some implementations, the UE 115-b may fully or partially cancel Sₓ before decoding S_{y}. The UE 115-a may treat S_{y}as noise/interference. The UE 115-b may fully or partially cancel Sₓ using prior information of Sₓ indicated by the network (e.g., the RU 205).

In some cases, the multiplexing may be orthogonal (e.g., OMA) for Sₓ (e.g., SDT packet for UE 115-a) from a first source (e.g., RAT/operator/service) and for S_{y}(e.g., SDT packet for UE 115-b) from a second source (e.g., RAT/operator/service). In such cases, the UE 115-a may not perform interference cancellation for S_{y}, and vice versa.

In some other cases, the multiplexing for Sₓ and S_{y} may be non-orthogonal (e.g., NOMA). In such cases, whether or not interference cancellation is performed by the UE 115-a, the UE 115-b, or both, may be based on UE capabilities, network signaling (e.g., RRC signaling, MAC control element (CE) signaling, downlink control information (DCI)), or both. In some implementations, the UE 115 may support relatively advanced capability for interference cancelation during SDT, and the network may provide assistance information (e.g., via North American Industry Classification System (NAICS) signaling). The assistance information may include a modulation format, a scrambling sequence, or a power ratio, among other multiple access parameters, for the multiplexing of Sₓ and S_{y}. In some examples, the UE 115 may perform the interference cancelation based on the UE 115 supporting the capability for interference cancelation, or based on the network-provided assistance information, or both. Otherwise (e.g., if UE does not support interference cancelation, or network does not provide assistance information for interference cancelation, or both), the UE 115-a may treat the interference from the SDT packet for the other UE 115-b as noise without cancellation. In some cases, because SDT targets relatively small data volume and low modulation and coding scheme (MCS), a NOMA scheme may be supported for UEs 115 with and without interference cancelation capabilities.

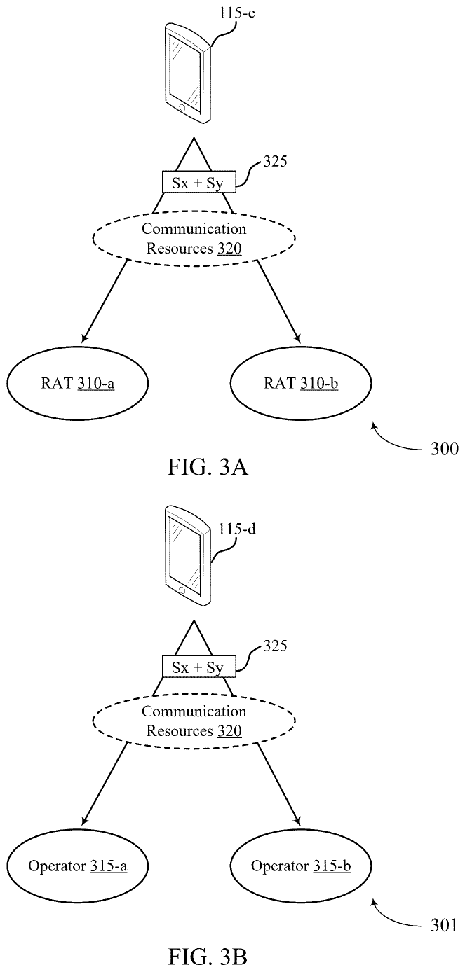

FIGS. 3A and 3B shows an example of a wireless communications system 300 and a wireless communications system 301, respectively, that supports multiplexing of SDTs in accordance with one or more aspects of the present disclosure. The wireless communications system 300 and the wireless communications system 301 may implement or may be implemented by aspects of the wireless communications system 100. For example, the wireless communications system 300 and the wireless communications system 301 may include a UE 115-c and a UE 115-d, respectively, which may be examples of the UE 115 as described with reference to FIG. 1. The wireless communications system 300 may include a RAT 310-a and a RAT 310-b, which may each be implemented by or be examples of aspects of one or more network entities 105 as described with reference to FIG. 1. The wireless communications system 301 may include an operator 315-a and an operator 315-b, which may each be implemented by or be examples of aspects of one or more network entities 105 as described with reference to FIG. 1.

In the examples of the wireless communications system 300 and the wireless communications system 301, a UE 115 may transmit a multiplexed transmission 325 via communication resources 320 (e.g., time/frequency resources) that includes multiple SDTs (e.g., SDT packets) for different RATs 310 or operators 315 or services each corresponding to a respective RU. For example, the multiplexed transmission 325 may include a first SDT, Sₓ (e.g., a first SDT packet) to a first RU of a first RAT 310-a or a first operator 315-a or a first service, and a second SDT, S_{y} (e.g., a second SDT packet) to a second RU of a second RAT 310-b or a second operator 315-b or a second service. Accordingly, a multi-sim UE 115 may be capable of concurrent SDT communications with different RATs 310 (e.g., 5G and 6G), or with different operators 315, or both, of corresponding RUs. The different RATs 310 or operators 315 may share the communication resources 320 on downlink or uplink using orthogonal (e.g., OMA) or non-orthogonal (e.g., NOMA) multiplexing schemes.

In the example of wireless communications system 300, the UE 115-c may transmit Sₓ to a first RU of the first RAT 310-a (e.g., a legacy RAT). The RAT 310-a may treat S_{y} as noise/interference. The UE 115-c may transmit S_{y} to a second RU of the second RAT 310-b (e.g., a non-legacy RAT). In some implementations, the RAT 310-b may fully or partially cancel Sₓ before decoding S_{y}. The RAT 310-b may fully or partially cancel Sₓ using prior information of Sₓ indicated by the UE 115-c.

In the example of wireless communications system 301, the UE 115-d may transmit Sₓ to an RU of the first operator 315-a. The operator 315-a may treat S_{y} as noise/interference. The UE 115-d may transmit S_{y} to an RU of the second operator 315-b. In some implementations, the operator 315-b may fully or partially cancel Sₓ before decoding S_{y}. The operator 315-b may fully or partially cancel Sₓ using prior information of Sₓ indicated by the UE 115-d.

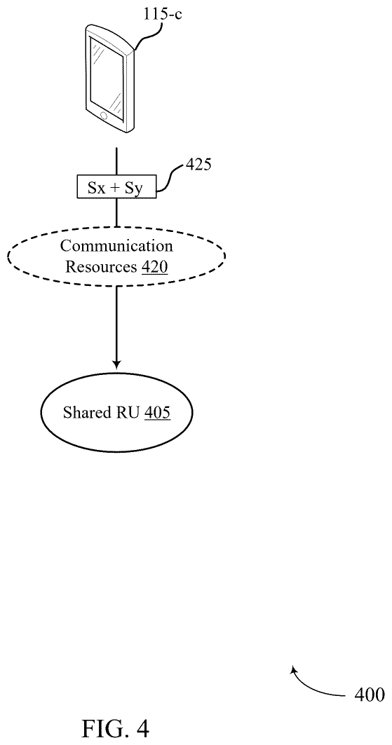

FIG. 4 shows an example of a wireless communications system 400 that supports multiplexing of SDTs in accordance with one or more aspects of the present disclosure. The wireless communications system 400 may implement or may be implemented by aspects of the wireless communications system 100. For example, the wireless communications system 400 may include a UE 115-e, which may be an example of the UE 115 as described with reference to FIG. 1. The wireless communications system 400 may include an RU 405 which may be implemented by one or more network entities 105 (e.g., the RU 405 is shared between multiple RATs, multiple operators), as described with reference to FIG. 1.

In the examples of the wireless communications system 400, a UE 115-e may transmit a multiplexed transmission 425 via communication resources 420 (e.g., time/frequency resources) that includes multiple SDTs (e.g., SDT packets) for different RATs or operators or services which share an RU 405. For example, the multiplexed transmission 425 may include a first SDT, Sₓ (e.g., a first SDT packet) for a first RAT or a first operator or a first service of the shared RU 405, and a second SDT, S_{y} (e.g., a second SDT packet) for a second RAT or a second operator or a second service of the shared RU 405. Accordingly, a multi-sim UE 115-e may be capable of concurrent SDT communications with different RATs (e.g., 5G and 6G), or with different operators, or both, which implement a shared RU 405. In such cases, the UE 115-e may support both the first RAT and the second RAT, or the UE 115-e may be subscribed to both the first operator and the second operator. The different RATs or operators may share the communication resources 420 on downlink or uplink using orthogonal (e.g., OMA) or non-orthogonal (e.g., NOMA) multiplexing schemes.

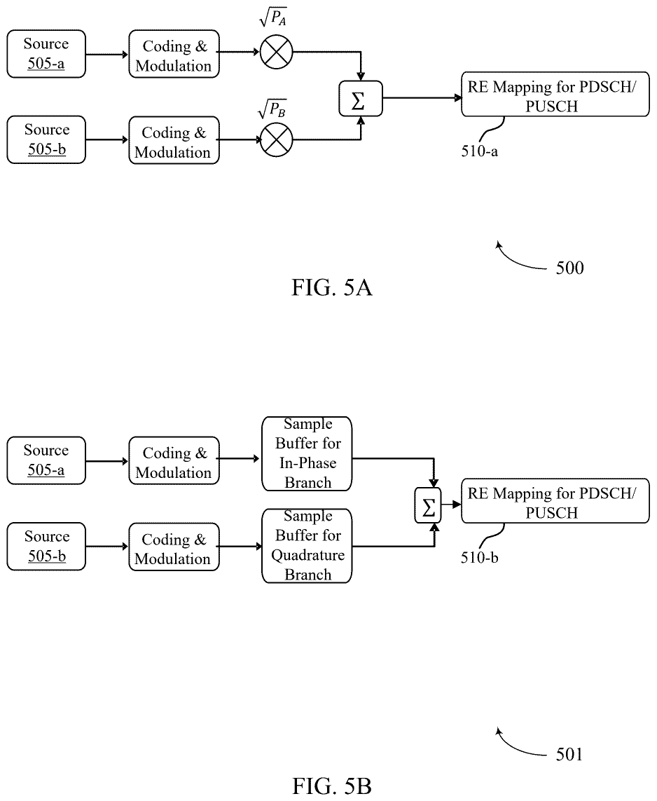

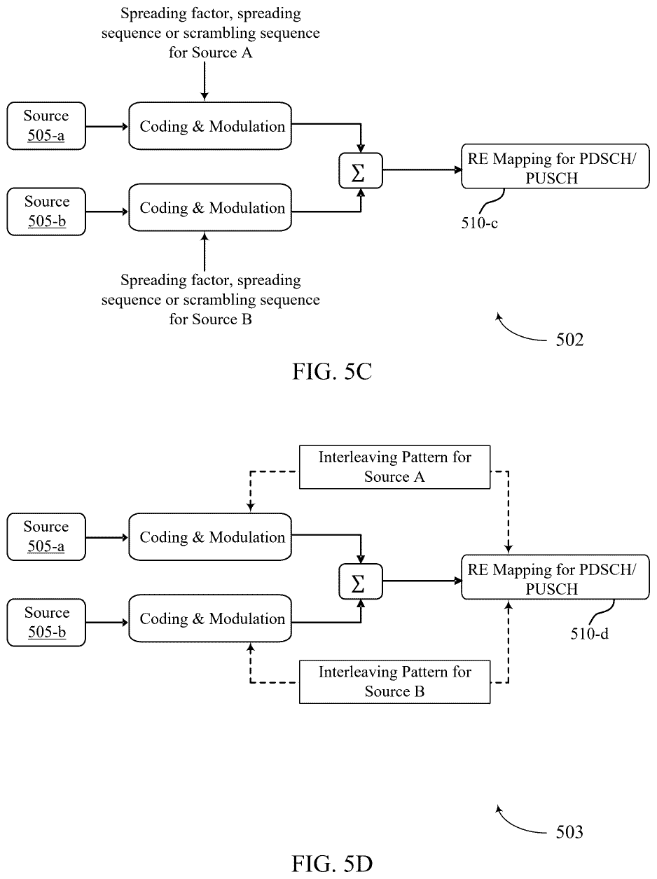

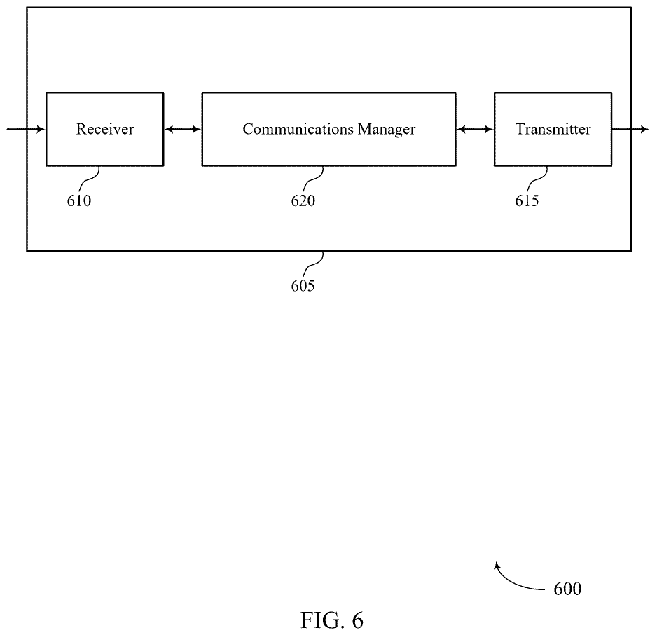

FIGS. 5A-5D show examples of multiplexing schemes 500, 501, 502, and 503, respectively, that support multiplexing of SDTs in accordance with one or more aspects of the present disclosure. The multiplexing schemes 500, 501, 502, and 503 may be implemented by aspects of any of the wireless communications system 100 through 400 as described with reference to FIG. 1-4. For example, the multiplexing schemes 500, 501, 502, and 503 may be implemented by a UE 115 or a network entity 105 to encode and communicate SDTs via shared communication resources (e.g., communication resources 220, communication resources 320, communication resources 420), as described with reference to FIG. 1-4.

To differentiate SDT packets associated with (e.g., directed to, received from) different sources 505, SDTs may be multiplexed (e.g., by a UE, by a network entity) according to one or more multiple access parameters (e.g., multiplexing parameters). The sources 505 may be examples of different RATs, different operators, different services, or different cells associated with a network (e.g., a network entity 105), among other possible implementations. A multiplexed transmission encoded according to the described multiplexing schemes may include a first SDT packet associated with the source 505-a and a second SDT packet associated with the source 505-b.

In the example of multiplexing scheme 500, the multiplexed transmission with the first SDT packet and the second SDT packet may implement non-orthogonal multiplexing. For example, the first SDT packet associated with the source 505-a may be transmitted (e.g., by the UE, by network entity) with a first transmit power and the second SDT packet associated with the source 505-b may be transmitted with a second transmit power. The first transmit power may correspond to the source 505-a and the second transmit power may correspond to the source 505-b (e.g., as indicated via assistance information or other configuration information). The quadrature phase portion and the in-phase portion may be used to derive (e.g., may be indicative of) a resource element (RE) mapping 510-a for PDSCH or PUSCH transmissions encoded according to the multiplexing scheme 500.

In the example of multiplexing scheme 501, the multiplexed transmission with the first SDT packet and the second SDT packet may implement orthogonal multiplexing. For example, the first SDT packet may be encoded (e.g., by the UE, by the network entity) using an in-phase portion of a first signal that is modulated according to orthogonal frequency division multiplexing, and the second SDT packet may be encoded using a quadrature phase portion of the first signal. The quadrature phase portion may correspond to the source 505-a and the in-phase portion may correspond to the source 505-b (e.g., as indicated via assistance information or other configuration information). The quadrature phase portion and the in-phase portion may be used to derive (e.g., may be indicative of) a RE mapping 510-b for PDSCH or PUSCH transmissions encoded according to the multiplexing scheme 501.

In the example of multiplexing scheme 502, the multiplexed transmission with the first SDT packet and the second SDT packet may implement different spreading or scrambling codes. The spreading or scrambling codes may be orthogonal or quasi-orthogonal at a bit or symbol or RE level. For example, the first SDT packet may be encoded (e.g., by the UE, by the network entity) using a first spreading factor, a first spreading sequence, or a first scrambling sequence, and the second SDT packet may be encoded using a second spreading factor, a second spreading sequence, or a second scrambling sequence. The first spreading factor, the first spreading sequence, or the first scrambling sequence may correspond to the source 505-a and the second spreading factor, the second spreading sequence, or the second scrambling sequence may correspond to the source 505-b (e.g., as indicated via assistance information or other configuration information). The spreading factors, spreading sequences, or scrambling sequences for each of the first SDT packet and the second SDT packet may be used to derive (e.g., may be indicative of) a RE mapping 510-c for PDSCH or PUSCH transmissions encoded according to the multiplexing scheme 502.

In the example of multiplexing scheme 502, the multiplexed transmission with the first SDT packet and the second SDT packet may implement one or more interleaving patterns. The interleaving patterns may interleave at a bit or symbol or RE level and may support orthogonal or non-orthogonal multiplexing. For example, multiplexed transmission may be encoded (e.g., by the UE, by the network entity) such that the first SDT packet is included in (e.g., encoded via) a first subset of symbols of a first signal and the second SDT packet included in (e.g., encoded via) a second subset of symbols of the first signal. The first subset of symbols including the first SDT packet and the second subset of symbols including the second SDT packet may be interleaved within the first signal (e.g., as indicated via assistance information or other configuration information). The first subset of interleaved symbols and the second subset of interleaved symbols may be used to derive (e.g., may be indicative of) a RE mapping 510-d for PDSCH or PUSCH transmissions encoded according to the multiplexing scheme 503.

In some examples, SDT packets from different sources 505 (e.g., RATs or operators) may be multiplexed on downlink (e.g., by a network entity) using the same radio resources according to any of the multiplexing schemes described herein. In some implementations, assistance information provided by a network entity (e.g., for interference cancellation suppression, or mitigation) may indicate the multiplexing scheme that is used. For example, the assistance information may be based on the semi-persistent or dynamic scheduling information of another UE (e.g., transmit power offset, MCS, scrambling/spreading schemes). The network entity may signal the assistance information via RRC, MAC CE, or DCI signaling. In some implementations, the assistance information for different sources 505 (e.g., RATs or operators) may be separately transmitted via TDM, FDM, or space-division multiplexing (SDM). In some implementations, the assistance information may be jointly transmitted and separately parsed or decoded via different MAC headers or DCI fields. In some implementations, a DCI carrying the scheduling information may be mapped to a multi-stage grant. In some implementations, a DCI carrying the scheduling information may be multiplexed with the one or more SDT packets by rate matching or puncturing.

In some examples, SDT packets to different sources 505 (e.g., RATs or operators) may be multiplexed on uplink (e.g., by a UE) using the same radio resources according to any of the multiplexing schemes described herein. In some implementations, assistance information provided by the UE (e.g., for interference cancellation suppression, or mitigation) may indicate the multiplexing scheme that is used. The UE may signal the assistance information via RRC, MAC CE, or uplink control information (UCI) signaling. In some implementations, the assistance information for different sources 505 (e.g., RATs or operators) may be separately transmitted via TDM, FDM, or SDM. In some implementations, the assistance information may be jointly transmitted and separately parsed or decoded via different MAC headers or UCI fields. In some implementations, a UCI carrying the scheduling information may be multiplexed with the one or more SDT packets by rate matching or puncturing.

FIG. 6 shows a block diagram 600 of a device 605 that supports multiplexing of SDTs in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to multiplexing of SDTs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multiplexing of SDTs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of multiplexing of SDTs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs. The communications manager 620 is capable of, configured to, or operable to support a means for transmitting, via a first set of communication resources, the first SDT associated with the first service based on the first set of multiple access parameters. The communications manager 620 is capable of, configured to, or operable to support a means for transmitting, via the first set of communication resources, the second SDT associated with the second service based on the second set of multiple access parameters.

Additionally, or alternatively, the communications manager 620 may support wireless communications in accordance with examples as disclosed herein. For example, the communications manager 620 is capable of, configured to, or operable to support a means for receiving, via a first set of communication resources, a first SDT associated with a first service. The communications manager 620 is capable of, configured to, or operable to support a means for receiving, via the first set of communication resources, a second SDT associated with a second service, each of the first SDT and the second SDT including a respective amount of data less than a threshold amount of data associated with SDTs. The communications manager 620 is capable of, configured to, or operable to support a means for selectively decoding one of the first SDT or the second SDT.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

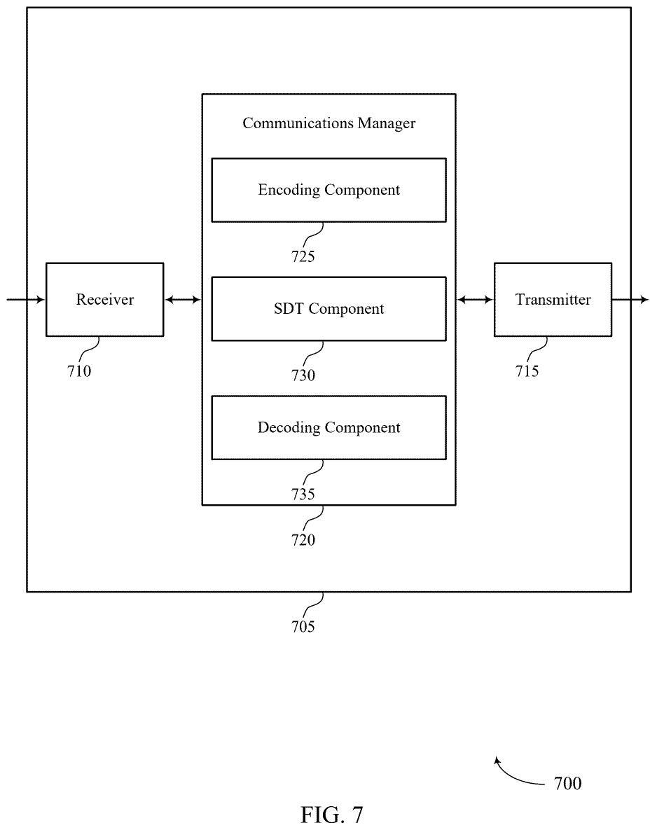

FIG. 7 shows a block diagram 700 of a device 705 that supports multiplexing of SDTs in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to multiplexing of SDTs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to multiplexing of SDTs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of multiplexing of SDTs as described herein. For example, the communications manager 720 may include an encoding component 725, an SDT component 730, a decoding component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The encoding component 725 is capable of, configured to, or operable to support a means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs. The SDT component 730 is capable of, configured to, or operable to support a means for transmitting, via a first set of communication resources, the first SDT associated with the first service based on the first set of multiple access parameters. The SDT component 730 is capable of, configured to, or operable to support a means for transmitting, via the first set of communication resources, the second SDT associated with the second service based on the second set of multiple access parameters.

Additionally, or alternatively, the communications manager 720 may support wireless communications in accordance with examples as disclosed herein. The SDT component 730 is capable of, configured to, or operable to support a means for receiving, via a first set of communication resources, a first SDT associated with a first service. The SDT component 730 is capable of, configured to, or operable to support a means for receiving, via the first set of communication resources, a second SDT associated with a second service, each of the first SDT and the second SDT including a respective amount of data less than a threshold amount of data associated with SDTs. The decoding component 735 is capable of, configured to, or operable to support a means for selectively decoding one of the first SDT or the second SDT.

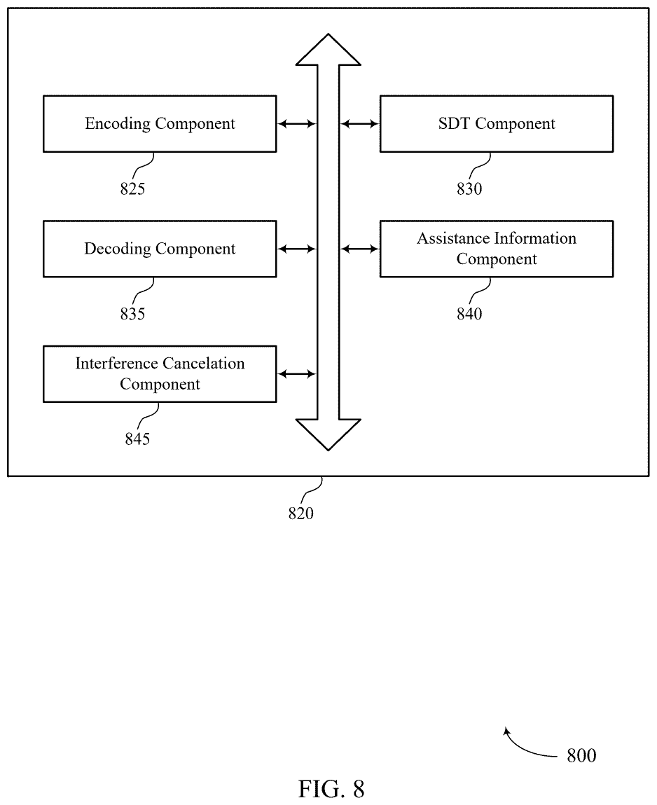

FIG. 8 shows a block diagram 800 of a communications manager 820 that supports multiplexing of SDTs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of multiplexing of SDTs as described herein. For example, the communications manager 820 may include an encoding component 825, an SDT component 830, a decoding component 835, an assistance information component 840, an interference cancelation component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The encoding component 825 is capable of, configured to, or operable to support a means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs. The SDT component 830 is capable of, configured to, or operable to support a means for transmitting, via a first set of communication resources, the first SDT associated with the first service based on the first set of multiple access parameters. In some examples, the SDT component 830 is capable of, configured to, or operable to support a means for transmitting, via the first set of communication resources, the second SDT associated with the second service based on the second set of multiple access parameters.

In some examples, the first SDT is associated with a first RU corresponding to the first service and the second SDT is associated with a second RU corresponding to the second service.

In some examples, both the first SDT and the second SDT are associated with a first RU shared between the first service and the second service.

In some examples, to support transmitting the first SDT and transmitting the second SDT, the SDT component 830 is capable of, configured to, or operable to support a means for transmitting the first SDT with a first transmit power via the first set of communication resources, the first transmit power associated with the first service. In some examples, to support transmitting the first SDT and transmitting the second SDT, the SDT component 830 is capable of, configured to, or operable to support a means for transmitting the second SDT with a second transmit power via the first set of communication resources, the second transmit power associated with the second service.

In some examples, the first SDT is encoded using an in-phase portion of a first signal that is modulated according to orthogonal frequency division multiplexing. In some examples, the second SDT is encoded using a quadrature phase portion of the first signal. In some examples, the first service is associated with the in-phase portion of the first signal and the second service is associated with the quadrature phase portion of the first signal.

In some examples, the first SDT is encoded in accordance with a first spreading factor, a first spreading sequence, or a first scrambling sequence associated with the first service. In some examples, the second SDT is encoded in accordance with a second spreading factor, a second spreading sequence, or a second scrambling sequence associated with the second service.

In some examples, the first SDT is encoded via a first subset of symbols of a first signal and the second SDT is encoded via a second subset of symbols of the first signal. In some examples, the first subset of symbols associated with the first service and the second subset of symbols associated with the second service are interleaved within the first signal.

In some examples, the assistance information component 840 is capable of, configured to, or operable to support a means for transmitting signaling indicative of assistance information associated with multiple access SDTs, the assistance information indicating the first set of multiple access parameters associated with the first service, the second set of multiple access parameters associated with the second service, or both.

In some examples, the signaling indicative of the assistance information includes RRC signaling, MAC-CE signaling, UCI signaling, or a combination thereof.

In some examples, the first service is associated with a first radio access network technology, a first network operator, or both. In some examples, the second service is associated with a second radio access network technology, a second network operator, or both.

Additionally, or alternatively, the communications manager 820 may support wireless communications in accordance with examples as disclosed herein. In some examples, the SDT component 830 is capable of, configured to, or operable to support a means for receiving, via a first set of communication resources, a first SDT associated with a first service. In some examples, the SDT component 830 is capable of, configured to, or operable to support a means for receiving, via the first set of communication resources, a second SDT associated with a second service, each of the first SDT and the second SDT including a respective amount of data less than a threshold amount of data associated with SDTs. The decoding component 835 is capable of, configured to, or operable to support a means for selectively decoding one of the first SDT or the second SDT.

In some examples, to support selectively decoding one of the first SDT or the second SDT, the interference cancelation component 845 is capable of, configured to, or operable to support a means for performing an interference cancellation procedure to cancel interference associated with one of the first SDT or the second SDT.

In some examples, both the first SDT and the second SDT are associated with a first RU shared between the first service and the second service.

In some examples, to support receiving the first SDT and receiving the second SDT, the SDT component 830 is capable of, configured to, or operable to support a means for receiving the first SDT in accordance with a first transmit power via the first set of communication resources, the first transmit power associated with the first service. In some examples, to support receiving the first SDT and receiving the second SDT, the SDT component 830 is capable of, configured to, or operable to support a means for receiving the second SDT in accordance with a second transmit power via the first set of communication resources, the second transmit power associated with the second service, where selectively decoding one of the first SDT or the second SDT is based on the first transmit power, the second transmit power, or both.

In some examples, the first service is associated with an in-phase portion of a first signal that is modulated according to orthogonal frequency division multiplexing and the second service is associated with a quadrature phase portion of the first signal. In some examples, selectively decoding one of the first SDT or the second SDT includes selectively decoding the in-phase portion of the first signal or the quadrature phase portion of the first signal.

In some examples, selectively decoding one of the first SDT or the second SDT is based on a first spreading factor, a first spreading sequence, or a first scrambling sequence associated with the first service, a second spreading factor, a second spreading sequence, or a second scrambling sequence associated with the second service, or a combination thereof.

In some examples, the first SDT is received via a first subset of symbols of a first signal and the second SDT is received via a second subset of symbols of the first signal. In some examples, the first subset of symbols associated with the first service and the second subset of symbols associated with the second service are interleaved within the first signal. In some examples, selectively decoding one of the first SDT or the second SDT includes selectively decoding the first subset of symbols of the first signal or the second subset of symbols of the first signal.

In some examples, the assistance information component 840 is capable of, configured to, or operable to support a means for receiving signaling indicative of assistance information associated with multiple access SDTs, the assistance information indicating a first set of multiple access parameters associated with the first service, a second set of multiple access parameters associated with the second service, or both, where selectively decoding one of the first SDT or the second SDT is based on the assistance information.

In some examples, the signaling indicative of the assistance information includes RRC signaling, MAC-CE control element signaling, DCI signaling, or a combination thereof.

In some examples, the first service is associated with a first radio access network technology, a first network operator, or both. In some examples, the second service is associated with a second radio access network technology, a second network operator, or both.

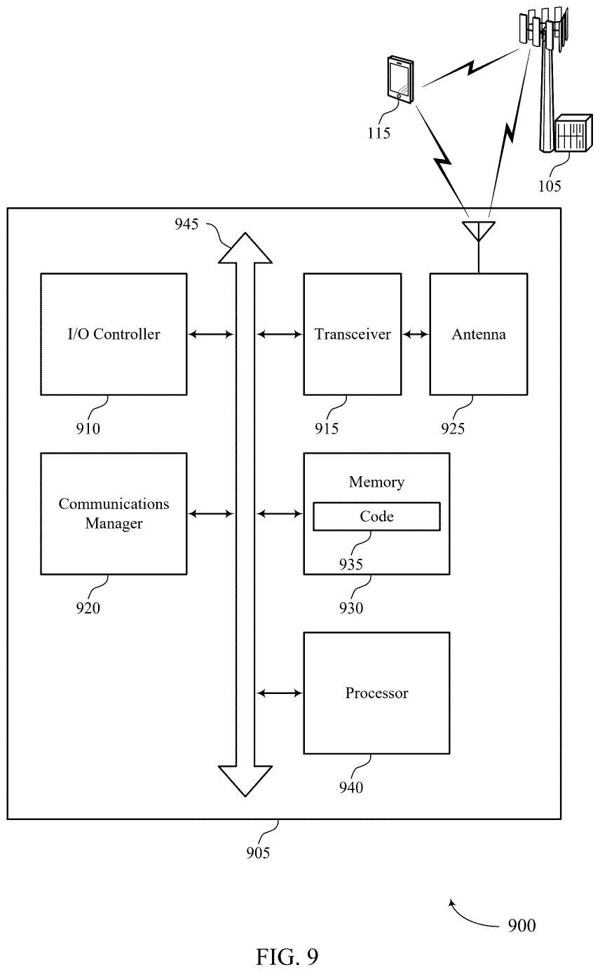

FIG. 9 shows a diagram of a system 900 including a device 905 that supports multiplexing of SDTs in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting multiplexing of SDTs). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs. The communications manager 920 is capable of, configured to, or operable to support a means for transmitting, via a first set of communication resources, the first SDT associated with the first service based on the first set of multiple access parameters. The communications manager 920 is capable of, configured to, or operable to support a means for transmitting, via the first set of communication resources, the second SDT associated with the second service based on the second set of multiple access parameters.

Additionally, or alternatively, the communications manager 920 may support wireless communications in accordance with examples as disclosed herein. For example, the communications manager 920 is capable of, configured to, or operable to support a means for receiving, via a first set of communication resources, a first SDT associated with a first service. The communications manager 920 is capable of, configured to, or operable to support a means for receiving, via the first set of communication resources, a second SDT associated with a second service, each of the first SDT and the second SDT including a respective amount of data less than a threshold amount of data associated with SDTs. The communications manager 920 is capable of, configured to, or operable to support a means for selectively decoding one of the first SDT or the second SDT.

By including or configuring the communications manager 920 in accordance with examples as described herein, the device 905 may support techniques for improved communication reliability, reduced latency, improved user experience related to reduced processing, reduced power consumption, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of multiplexing of SDTs as described herein, or the at least one processor 940 and the at least one memory 930 may be otherwise configured to, individually or collectively, perform or support such operations.

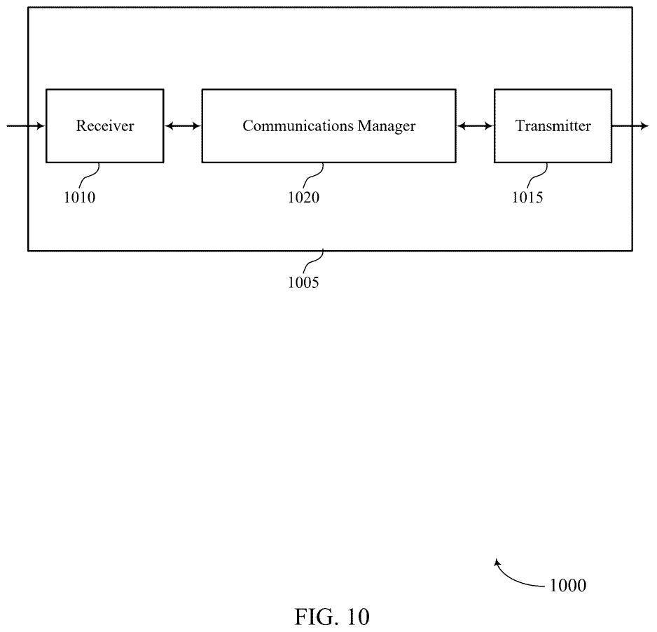

FIG. 10 shows a block diagram 1000 of a device 1005 that supports multiplexing of SDTs in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of multiplexing of SDTs as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs. The communications manager 1020 is capable of, configured to, or operable to support a means for transmitting, via a first set of communication resources, the first SDT associated with the first service based on the first set of multiple access parameters. The communications manager 1020 is capable of, configured to, or operable to support a means for transmitting, via the first set of communication resources, the second SDT associated with the second service based on the second set of multiple access parameters.

Additionally, or alternatively, the communications manager 1020 may support wireless communications in accordance with examples as disclosed herein. For example, the communications manager 1020 is capable of, configured to, or operable to support a means for receiving, via a first set of communication resources, a first SDT associated with a first service. The communications manager 1020 is capable of, configured to, or operable to support a means for receiving, via the first set of communication resources, a second SDT associated with a second service, each of the first SDT and the second SDT including a respective amount of data less than a threshold amount of data associated with SDTs. The communications manager 1020 is capable of, configured to, or operable to support a means for selectively decoding one of the first SDT or the second SDT.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

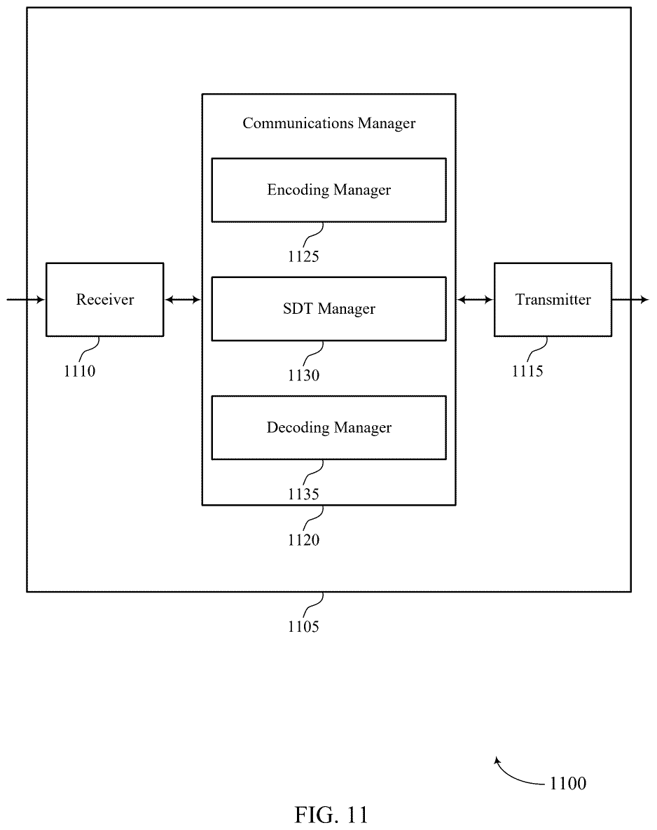

FIG. 11 shows a block diagram 1100 of a device 1105 that supports multiplexing of SDTs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of multiplexing of SDTs as described herein. For example, the communications manager 1120 may include an encoding manager 1125, an SDT manager 1130, a decoding manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The encoding manager 1125 is capable of, configured to, or operable to support a means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs. The SDT manager 1130 is capable of, configured to, or operable to support a means for transmitting, via a first set of communication resources, the first SDT associated with the first service based on the first set of multiple access parameters. The SDT manager 1130 is capable of, configured to, or operable to support a means for transmitting, via the first set of communication resources, the second SDT associated with the second service based on the second set of multiple access parameters.

Additionally, or alternatively, the communications manager 1120 may support wireless communications in accordance with examples as disclosed herein. The SDT manager 1130 is capable of, configured to, or operable to support a means for receiving, via a first set of communication resources, a first SDT associated with a first service. The SDT manager 1130 is capable of, configured to, or operable to support a means for receiving, via the first set of communication resources, a second SDT associated with a second service, each of the first SDT and the second SDT including a respective amount of data less than a threshold amount of data associated with SDTs. The decoding manager 1135 is capable of, configured to, or operable to support a means for selectively decoding one of the first SDT or the second SDT.

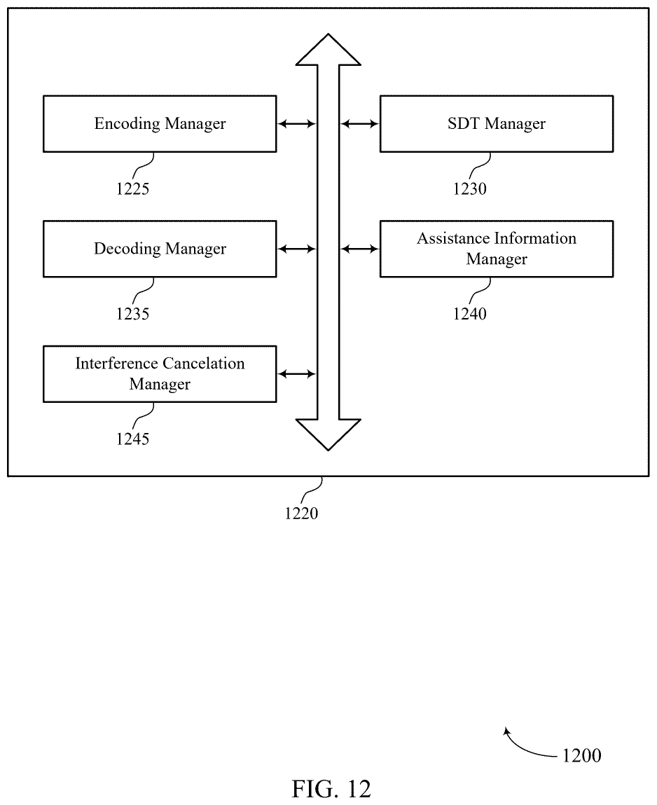

FIG. 12 shows a block diagram 1200 of a communications manager 1220 that supports multiplexing of SDTs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of multiplexing of SDTs as described herein. For example, the communications manager 1220 may include an encoding manager 1225, an SDT manager 1230, a decoding manager 1235, an assistance information manager 1240, an interference cancelation manager 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The encoding manager 1225 is capable of, configured to, or operable to support a means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs. The SDT manager 1230 is capable of, configured to, or operable to support a means for transmitting, via a first set of communication resources, the first SDT associated with the first service based on the first set of multiple access parameters. In some examples, the SDT manager 1230 is capable of, configured to, or operable to support a means for transmitting, via the first set of communication resources, the second SDT associated with the second service based on the second set of multiple access parameters.

In some examples, the first SDT is associated with a first RU corresponding to the first service and the second SDT is associated with a second RU corresponding to the second service.

In some examples, both the first SDT and the second SDT are associated with a first RU shared between the first service and the second service of the network entity.

In some examples, to support transmitting the first SDT and transmitting the second SDT, the SDT manager 1230 is capable of, configured to, or operable to support a means for transmitting the first SDT with a first transmit power via the first set of communication resources, the first transmit power associated with the first service. In some examples, to support transmitting the first SDT and transmitting the second SDT, the SDT manager 1230 is capable of, configured to, or operable to support a means for transmitting the second SDT with a second transmit power via the first set of communication resources, the second transmit power associated with the second service.

In some examples, the first SDT is encoded using an in-phase portion of a first signal that is modulated according to orthogonal frequency division multiplexing. In some examples, the second SDT is encoded using a quadrature phase portion of the first signal. In some examples, the first service is associated with the in-phase portion of the first signal and the second service is associated with the quadrature phase portion of the first signal.

In some examples, the first SDT is encoded in accordance with a first spreading factor, a first spreading sequence, or a first scrambling sequence associated with the first service. In some examples, the second SDT is encoded in accordance with a second spreading factor, a second spreading sequence, or a second scrambling sequence associated with the second service.

In some examples, the first SDT is encoded via a first subset of symbols of a first signal and the second SDT is encoded via a second subset of symbols of the first signal. In some examples, the first subset of symbols associated with the first service and the second subset of symbols associated with the second service are interleaved within the first signal.

In some examples, the assistance information manager 1240 is capable of, configured to, or operable to support a means for transmitting signaling indicative of assistance information associated with multiple access SDTs, the assistance information indicating the first set of multiple access parameters associated with the first service, the second set of multiple access parameters associated with the second service, or both.

In some examples, the signaling indicative of the assistance information includes RRC signaling, MAC-CE signaling, DCI signaling, or a combination thereof. In some examples, the first service is associated with a first radio access network technology, a first network operator, or both. In some examples, the second service is associated with a second radio access network technology, a second network operator, or both.

Additionally, or alternatively, the communications manager 1220 may support wireless communications in accordance with examples as disclosed herein. In some examples, the SDT manager 1230 is capable of, configured to, or operable to support a means for receiving, via a first set of communication resources, a first SDT associated with a first service. In some examples, the SDT manager 1230 is capable of, configured to, or operable to support a means for receiving, via the first set of communication resources, a second SDT associated with a second service, each of the first SDT and the second SDT including a respective amount of data less than a threshold amount of data associated with SDTs. The decoding manager 1235 is capable of, configured to, or operable to support a means for selectively decoding one of the first SDT or the second SDT.

In some examples, to support selectively decoding one of the first SDT or the second SDT, the interference cancelation manager 1245 is capable of, configured to, or operable to support a means for performing an interference cancellation procedure to cancel interference associated with one of the first SDT or the second SDT.

In some examples, both the first SDT and the second SDT are associated with a first RU shared between the first service and the second service.

In some examples, to support receiving the first SDT and receiving the second SDT, the SDT manager 1230 is capable of, configured to, or operable to support a means for receiving the first SDT in accordance with a first transmit power via the first set of communication resources, the first transmit power associated with the first service. In some examples, to support receiving the first SDT and receiving the second SDT, the SDT manager 1230 is capable of, configured to, or operable to support a means for receiving the second SDT in accordance with a second transmit power via the first set of communication resources, the second transmit power associated with the second service, where selectively decoding one of the first SDT or the second SDT is based on the first transmit power, the second transmit power, or both.

In some examples, the first service is associated with an in-phase portion of a first signal that is modulated according to orthogonal frequency division multiplexing and the second service is associated with a quadrature phase portion of the first signal. In some examples, selectively decoding one of the first SDT or the second SDT includes selectively decoding the in-phase portion of the first signal or the quadrature phase portion of the first signal.

In some examples, selectively decoding one of the first SDT or the second SDT is based on a first spreading factor, a first spreading sequence, or a first scrambling sequence associated with the first service, a second spreading factor, a second spreading sequence, or a second scrambling sequence associated with the second service, or a combination thereof.

In some examples, the first SDT is received via a first subset of symbols of a first signal and the second SDT is received via a second subset of symbols of the first signal. In some examples, the first subset of symbols associated with the first service and the second subset of symbols associated with the second service are interleaved within the first signal. In some examples, selectively decoding one of the first SDT or the second SDT includes selectively decoding the first subset of symbols of the first signal or the second subset of symbols of the first signal.

In some examples, the assistance information manager 1240 is capable of, configured to, or operable to support a means for receiving signaling indicative of assistance information associated with multiple access SDTs, the assistance information indicating a first set of multiple access parameters associated with the first service, a second set of multiple access parameters associated with the second service, or both, where selectively decoding one of the first SDT or the second SDT is based on the assistance information.

In some examples, the signaling indicative of the assistance information includes RRC signaling, MAC-CE signaling, UCI signaling, or a combination thereof.

In some examples, the first service is associated with a first radio access network technology, a first network operator, or both. In some examples, the second service is associated with a second radio access network technology, a second network operator, or both.

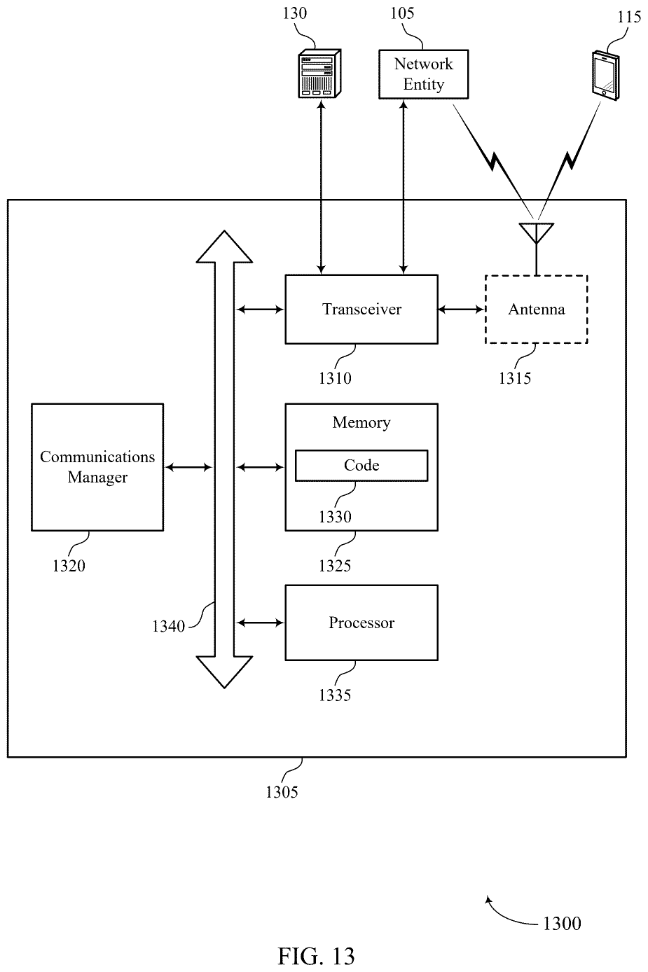

FIG. 13 shows a diagram of a system 1300 including a device 1305 that supports multiplexing of SDTs in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting multiplexing of SDTs). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for encoding a first SDT associated with a first service according to a first set of multiple access parameters and a second SDT associated with a second service according to a second set of multiple access parameters, each of the first SDT and the second SDT including a respective amount of data less than a threshold amount of data associated with SDTs. The communications manager 1320 is capable of, configured to, or operable to support a means for transmitting, via a first set of communication resources, the first SDT associated with the first service based on the first set of multiple access parameters. The communications manager 1320 is capable of, configured to, or operable to support a means for transmitting, via the first set of communication resources, the second SDT associated with the second service based on the second set of multiple access parameters.

Additionally, or alternatively, the communications manager 1320 may support wireless communications in accordance with examples as disclosed herein. For example, the communications manager 1320 is capable of, configured to, or operable to support a means for receiving, via a first set of communication resources, a first SDT associated with a first service. The communications manager 1320 is capable of, configured to, or operable to support a means for receiving, via the first set of communication resources, a second SDT associated with a second service, each of the first SDT and the second SDT including a respective amount of data less than a threshold amount of data associated with SDTs. The communications manager 1320 is capable of, configured to, or operable to support a means for selectively decoding one of the first SDT or the second SDT.

By including or configuring the communications manager 1320 in accordance with examples as described herein, the device 1305 may support techniques for improved communication reliability, reduced latency, improved user experience related to reduced processing, reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of multiplexing of SDTs as described herein, or the at least one processor 1335 and the at least one memory 1325 may be otherwise configured to, individually or collectively, perform or support such operations.

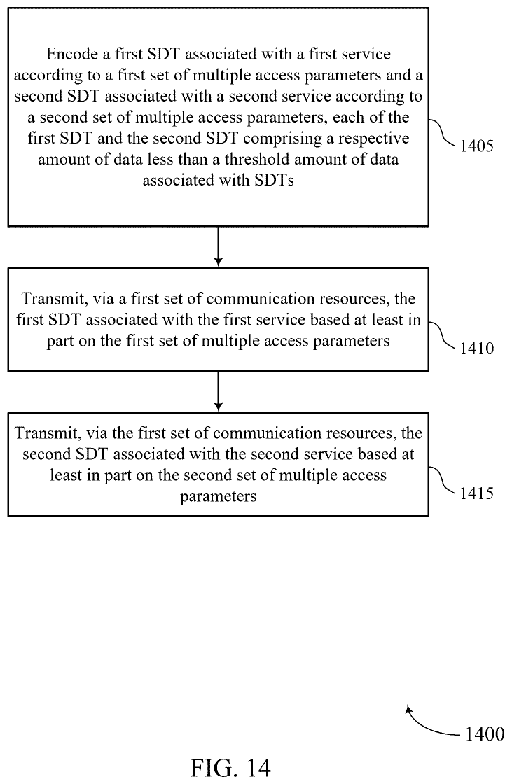

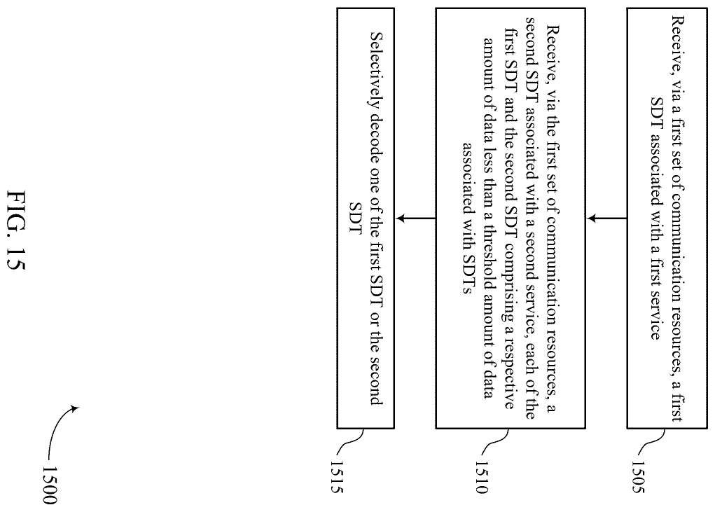

FIG. 14 shows a flowchart illustrating a method 1400 that supports multiplexing of SDTs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include encoding a first SDT associated with a first service according to a first set of multiple access parameters and a second SDT associated with a second service according to a second set of multiple access parameters, each of the first SDT and the second SDT comprising a respective amount of data less than a threshold amount of data associated with SDTs. The operations of 1405 may be performed in accordance with examples as disclosed herein. In some examples, aspects of the operations of 1405 may be performed by an encoding component 825 as described with reference to FIG. 8.

At 1410, the method may include transmitting, via a first set of communication resources, the first SDT associated with the first service based at least in part on the first set of multiple access parameters. The operations of 1410 may be performed in accordance with examples as disclosed herein. In some examples, aspects of the operations of 1410 may be performed by an SDT component 830 as described with reference to FIG. 8.

At 1415, the method may include transmitting, via the first set of communication resources, the second SDT associated with the second service based at least in part on the second set of multiple access parameters. The operations of 1415 may be performed in accordance with examples as disclosed herein. In some examples, aspects of the operations of 1415 may be performed by an SDT component 830 as described with reference to FIG. 8.

FIG. 15 shows a flowchart illustrating a method 1500 that supports multiplexing of SDTs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, via a first set of communication resources, a first SDT associated with a first service. The operations of 1505 may be performed in accordance with examples as disclosed herein. In some examples, aspects of the operations of 1505 may be performed by an SDT component 830 as described with reference to FIG. 8.

At 1510, the method may include receiving, via the first set of communication resources, a second SDT associated with a second service, each of the first SDT and the second SDT comprising a respective amount of data less than a threshold amount of data associated with SDTs. The operations of 1510 may be performed in accordance with examples as disclosed herein. In some examples, aspects of the operations of 1510 may be performed by an SDT component 830 as described with reference to FIG. 8.

At 1515, the method may include selectively decoding one of the first SDT or the second SDT. The operations of 1515 may be performed in accordance with examples as disclosed herein. In some examples, aspects of the operations of 1515 may be performed by a decoding component 835 as described with reference to FIG. 8.

The following provides an overview of aspects of the present disclosure:

Aspect 1: A method for wireless communications by a UE, comprising: encoding a first SDT associated with a first service according to a first set of multiple access parameters and a second SDT associated with a second service according to a second set of multiple access parameters, each of the first SDT and the second SDT comprising a respective amount of data less than a threshold amount of data associated with SDTs; transmitting, via a first set of communication resources, the first SDT associated with the first service based at least in part on the first set of multiple access parameters; and transmitting, via the first set of communication resources, the second SDT associated with the second service based at least in part on the second set of multiple access parameters.

Aspect 2: The method of aspect 1, wherein the first SDT is associated with a first radio unit corresponding to the first service and the second SDT is associated with a second radio unit corresponding to the second service.

Aspect 3: The method of any of aspects 1 through 2, wherein both the first SDT and the second SDT are associated with a first radio unit shared between the first service and the second service.

Aspect 4: The method of any of aspects 1 through 3, wherein transmitting the first SDT and transmitting the second SDT comprises: transmitting the first SDT with a first transmit power via the first set of communication resources, the first transmit power associated with the first service; and transmitting the second SDT with a second transmit power via the first set of communication resources, the second transmit power associated with the second service.

Aspect 5: The method of any of aspects 1 through 4, wherein the first SDT is encoded using an in-phase portion of a first signal that is modulated according to orthogonal frequency division multiplexing, and the second SDT is encoded using a quadrature phase portion of the first signal, the first service is associated with the in-phase portion of the first signal and the second service is associated with the quadrature phase portion of the first signal.

Aspect 6: The method of any of aspects 1 through 5, wherein the first SDT is encoded in accordance with a first spreading factor, a first spreading sequence, or a first scrambling sequence associated with the first service, and the second SDT is encoded in accordance with a second spreading factor, a second spreading sequence, or a second scrambling sequence associated with the second service.

Aspect 7: The method of any of aspects 1 through 6, wherein the first SDT is encoded via a first subset of symbols of a first signal and the second SDT is encoded via a second subset of symbols of the first signal, the first subset of symbols associated with the first service and the second subset of symbols associated with the second service are interleaved within the first signal.

Aspect 8: The method of any of aspects 1 through 7, further comprising: transmitting signaling indicative of assistance information associated with multiple access SDTs, the assistance information indicating the first set of multiple access parameters associated with the first service, the second set of multiple access parameters associated with the second service, or both.

Aspect 9: The method of aspect 8, wherein the signaling indicative of the assistance information comprises RRC signaling, MAC-CE signaling, UCI signaling, or a combination thereof.

Aspect 10: The method of any of aspects 1 through 9, wherein the first service is associated with a first RAT, a first network operator, or both, and the second service is associated with a second RAT, a second network operator, or both.

Aspect 11: A method for wireless communications by a UE, comprising: receiving, via a first set of communication resources, a first SDT associated with a first service; receiving, via the first set of communication resources, a second SDT associated with a second service, each of the first SDT and the second SDT comprising a respective amount of data less than a threshold amount of data associated with SDTs; and selectively decoding one of the first SDT or the second SDT.

Aspect 12: The method of aspect 11, wherein selectively decoding one of the first SDT or the second SDT comprises: performing an interference cancellation procedure to cancel interference associated with one of the first SDT or the second SDT.

Aspect 13: The method of any of aspects 11 through 12, wherein both the first SDT and the second SDT are associated with a first radio unit shared between the first service and the second service.

Aspect 14: The method of any of aspects 11 through 13, wherein receiving the first SDT and receiving the second SDT comprises: receiving the first SDT in accordance with a first transmit power via the first set of communication resources, the first transmit power associated with the first service; and receiving the second SDT in accordance with a second transmit power via the first set of communication resources, the second transmit power associated with the second service, wherein selectively decoding one of the first SDT or the second SDT is based at least in part on the first transmit power, the second transmit power, or both.

Aspect 15: The method of any of aspects 11 through 14, wherein the first service is associated with an in-phase portion of a first signal that is modulated according to orthogonal frequency division multiplexing and the second service is associated with a quadrature phase portion of the first signal, selectively decoding one of the first SDT or the second SDT comprises selectively decoding the in-phase portion of the first signal or the quadrature phase portion of the first signal.

Aspect 16: The method of any of aspects 11 through 15, wherein selectively decoding one of the first SDT or the second SDT is based at least in part on a first spreading factor, a first spreading sequence, or a first scrambling sequence associated with the first service, a second spreading factor, a second spreading sequence, or a second scrambling sequence associated with the second service, or a combination thereof.

Aspect 17: The method of any of aspects 11 through 16, wherein the first SDT is received via a first subset of symbols of a first signal and the second SDT is received via a second subset of symbols of the first signal, the first subset of symbols associated with the first service and the second subset of symbols associated with the second service are interleaved within the first signal, selectively decoding one of the first SDT or the second SDT comprises selectively decoding the first subset of symbols of the first signal or the second subset of symbols of the first signal.

Aspect 18: The method of any of aspects 11 through 17, further comprising: receiving signaling indicative of assistance information associated with multiple access SDTs, the assistance information indicating a first set of multiple access parameters associated with the first service, a second set of multiple access parameters associated with the second service, or both, wherein selectively decoding one of the first SDT or the second SDT is based at least in part on the assistance information.

Aspect 19: The method of aspect 18, wherein the signaling indicative of the assistance information comprises RRC signaling, MAC-CE signaling, DCI signaling, or a combination thereof.

Aspect 20: The method of any of aspects 11 through 19, wherein the first service is associated with a first RAT, a first network operator, or both, and the second service is associated with a second RAT, a second network operator, or both.

Aspect 21: A method for wireless communications by a network entity, comprising: encoding a first SDT associated with a first service according to a first set of multiple access parameters and a second SDT associated with a second service according to a second set of multiple access parameters, each of the first SDT and the second SDT comprising a respective amount of data less than a threshold amount of data associated with SDTs; transmitting, via a first set of communication resources, the first SDT associated with the first service based at least in part on the first set of multiple access parameters; and transmitting, via the first set of communication resources, the second SDT associated with the second service based at least in part on the second set of multiple access parameters.

Aspect 22: The method of aspect 21, wherein the first SDT is associated with a first radio unit corresponding to the first service and the second SDT is associated with a second radio unit corresponding to the second service.

Aspect 23: The method of any of aspects 21 through 22, wherein both the first SDT and the second SDT are associated with a first radio unit shared between the first service and the second service of the network entity.

Aspect 24: The method of any of aspects 21 through 23, wherein transmitting the first SDT and transmitting the second SDT comprises: transmitting the first SDT with a first transmit power via the first set of communication resources, the first transmit power associated with the first service; and transmitting the second SDT with a second transmit power via the first set of communication resources, the second transmit power associated with the second service.

Aspect 25: The method of any of aspects 21 through 24, wherein the first SDT is encoded using an in-phase portion of a first signal that is modulated according to orthogonal frequency division multiplexing, and the second SDT is encoded using a quadrature phase portion of the first signal, the first service is associated with the in-phase portion of the first signal and the second service is associated with the quadrature phase portion of the first signal.

Aspect 26: The method of any of aspects 21 through 25, wherein the first SDT is encoded in accordance with a first spreading factor, a first spreading sequence, or a first scrambling sequence associated with the first service, and the second SDT is encoded in accordance with a second spreading factor, a second spreading sequence, or a second scrambling sequence associated with the second service.

Aspect 27: The method of any of aspects 21 through 26, wherein the first SDT is encoded via a first subset of symbols of a first signal and the second SDT is encoded via a second subset of symbols of the first signal, the first subset of symbols associated with the first service and the second subset of symbols associated with the second service are interleaved within the first signal.

Aspect 28: The method of any of aspects 21 through 27, further comprising: transmitting signaling indicative of assistance information associated with multiple access SDTs, the assistance information indicating the first set of multiple access parameters associated with the first service, the second set of multiple access parameters associated with the second service, or both.

Aspect 29: The method of aspect 28, wherein the signaling indicative of the assistance information comprises RRC signaling, MAC-CE signaling, DCI signaling, or a combination thereof.

Aspect 30: The method of any of aspects 21 through 29, wherein the first service is associated with a first RAT, a first network operator, or both, and the second service is associated with a second RAT, a second network operator, or both.

Aspect 31: A method for wireless communications by a network entity, comprising: receiving, via a first set of communication resources, a first SDT associated with a first service; receiving, via the first set of communication resources, a second SDT associated with a second service, each of the first SDT and the second SDT comprising a respective amount of data less than a threshold amount of data associated with SDTs; and selectively decoding one of the first SDT or the second SDT.

Aspect 32: The method of aspect 31, wherein selectively decoding one of the first SDT or the second SDT comprises: performing an interference cancellation procedure to cancel interference associated with one of the first SDT or the second SDT.

Aspect 33: The method of any of aspects 31 through 32, wherein both the first SDT and the second SDT are associated with a first radio unit shared between the first service and the second service.

Aspect 34: The method of any of aspects 31 through 33, wherein receiving the first SDT and receiving the second SDT comprises: receiving the first SDT in accordance with a first transmit power via the first set of communication resources, the first transmit power associated with the first service; and receiving the second SDT in accordance with a second transmit power via the first set of communication resources, the second transmit power associated with the second service, wherein selectively decoding one of the first SDT or the second SDT is based at least in part on the first transmit power, the second transmit power, or both.

Aspect 35: The method of any of aspects 31 through 34, wherein the first service is associated with an in-phase portion of a first signal that is modulated according to orthogonal frequency division multiplexing and the second service is associated with a quadrature phase portion of the first signal, selectively decoding one of the first SDT or the second SDT comprises selectively decoding the in-phase portion of the first signal or the quadrature phase portion of the first signal.

Aspect 36: The method of any of aspects 31 through 35, wherein selectively decoding one of the first SDT or the second SDT is based at least in part on a first spreading factor, a first spreading sequence, or a first scrambling sequence associated with the first service, a second spreading factor, a second spreading sequence, or a second scrambling sequence associated with the second service, or a combination thereof.

Aspect 37: The method of any of aspects 31 through 36, wherein the first SDT is received via a first subset of symbols of a first signal and the second SDT is received via a second subset of symbols of the first signal, the first subset of symbols associated with the first service and the second subset of symbols associated with the second service are interleaved within the first signal, selectively decoding one of the first SDT or the second SDT comprises selectively decoding the first subset of symbols of the first signal or the second subset of symbols of the first signal.

Aspect 38: The method of any of aspects 31 through 37, further comprising: receiving signaling indicative of assistance information associated with multiple access SDTs, the assistance information indicating a first set of multiple access parameters associated with the first service, a second set of multiple access parameters associated with the second service, or both, wherein selectively decoding one of the first SDT or the second SDT is based at least in part on the assistance information.

Aspect 39: The method of aspect 38, wherein the signaling indicative of the assistance information comprises RRC signaling, MAC-CE signaling, UCI signaling, or a combination thereof.

Aspect 40: The method of any of aspects 31 through 39, wherein the first service is associated with a first RAT, a first network operator, or both, and the second service is associated with a second RAT, a second network operator, or both.

Aspect 41: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 10.

Aspect 42: A UE for wireless communications, comprising at least one means for performing a method of any of aspects 1 through 10.

Aspect 43: A non-transitory computer-readable medium storing code for wireless communications, the code comprising instructions executable by one or more processors (e.g., directly, indirectly, after pre-processing, without pre-processing) to perform a method of any of aspects 1 through 10.

Aspect 44: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 11 through 20.

Aspect 45: A UE for wireless communications, comprising at least one means for performing a method of any of aspects 11 through 20.

Aspect 46: A non-transitory computer-readable medium storing code for wireless communications, the code comprising instructions executable by one or more processors (e.g., directly, indirectly, after pre-processing, without pre-processing) to perform a method of any of aspects 11 through 20.

Aspect 47: A network entity for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the network entity to perform a method of any of aspects 21 through 30.

Aspect 48: A network entity for wireless communications, comprising at least one means for performing a method of any of aspects 21 through 30.

Aspect 49: A non-transitory computer-readable medium storing code for wireless communications, the code comprising instructions executable by one or more processors (e.g., directly, indirectly, after pre-processing, without pre-processing) to perform a method of any of aspects 21 through 30.

Aspect 50: A network entity for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the network entity to perform a method of any of aspects 31 through 40.

Aspect 51: A network entity for wireless communications, comprising at least one means for performing a method of any of aspects 31 through 40.

Aspect 52: A non-transitory computer-readable medium storing code for wireless communications, the code comprising instructions executable by one or more processors (e.g., directly, indirectly, after pre-processing, without pre-processing) to perform a method of any of aspects 31 through 40.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
encode a first small data transmission associated with a first service according to a first set of multiple access parameters and a second small data transmission associated with a second service according to a second set of multiple access parameters, each of the first small data transmission and the second small data transmission comprising a respective amount of data less than a threshold amount of data associated with small data transmissions;
transmit, via a first set of communication resources, the first small data transmission associated with the first service based at least in part on the first set of multiple access parameters; and
transmit, via the first set of communication resources, the second small data transmission associated with the second service based at least in part on the second set of multiple access parameters.

2. The UE of claim 1, wherein the first small data transmission is associated with a first radio unit corresponding to the first service and the second small data transmission is associated with a second radio unit corresponding to the second service.

3. The UE of claim 1, wherein both the first small data transmission and the second small data transmission are associated with a first radio unit shared between the first service and the second service.

4. The UE of claim 1, wherein, to transmit the first small data transmission and transmitting the second small data transmission, the one or more processors are individually or collectively operable to execute the code to cause the UE to:
transmit the first small data transmission with a first transmit power via the first set of communication resources, the first transmit power associated with the first service; and
transmit the second small data transmission with a second transmit power via the first set of communication resources, the second transmit power associated with the second service.

5. The UE of claim 1, wherein the first small data transmission is encoded using an in-phase portion of a first signal that is modulated according to orthogonal frequency division multiplexing and the second small data transmission is encoded using a quadrature phase portion of the first signal, wherein the first service is associated with the in-phase portion of the first signal and the second service is associated with the quadrature phase portion of the first signal.

6. The UE of claim 1, wherein the first small data transmission is encoded in accordance with a first spreading factor, a first spreading sequence, or a first scrambling sequence associated with the first service, and the second small data transmission is encoded in accordance with a second spreading factor, a second spreading sequence, or a second scrambling sequence associated with the second service.

7. The UE of claim 1, wherein the first small data transmission is encoded via a first subset of symbols of a first signal and the second small data transmission is encoded via a second subset of symbols of the first signal, the first subset of symbols associated with the first service and the second subset of symbols associated with the second service are interleaved within the first signal.

8. The UE of claim 1, wherein the one or more processors are individually or collectively further operable to execute the code to cause the UE to:
transmit signaling indicative of assistance information associated with multiple access small data transmissions, the assistance information indicating the first set of multiple access parameters associated with the first service, the second set of multiple access parameters associated with the second service, or both.

9. The UE of claim 8, wherein the signaling indicative of the assistance information comprises radio resource control (RRC) signaling, medium access control control element (MAC-CE) signaling, uplink control information (UCI) signaling, or a combination thereof.

10. The UE of claim 1, wherein the first service is associated with a first radio access network technology, a first network operator, or both, and the second service is associated with a second radio access network technology, a second network operator, or both.

11. A user equipment (UE), comprising:
one or more memories storing processor-executable code; and
one or more processors coupled with the one or more memories and individually or collectively operable to execute the code to cause the UE to:
receive, via a first set of communication resources, a first small data transmission associated with a first service;
receive, via the first set of communication resources, a second small data transmission associated with a second service, each of the first small data transmission and the second small data transmission comprising a respective amount of data less than a threshold amount of data associated with small data transmissions; and
selectively decode one of the first small data transmission or the second small data transmission.

12. The UE of claim 11, wherein, to selectively decode one of the first small data transmission or the second small data transmission, the one or more processors are individually or collectively operable to execute the code to cause the UE to:
perform an interference cancellation procedure to cancel interference associated with one of the first small data transmission or the second small data transmission.

13. The UE of claim 11, wherein both the first small data transmission and the second small data transmission are associated with a first radio unit shared between the first service and the second service.

14. The UE of claim 11, wherein, to receive the first small data transmission and receiving the second small data transmission, the one or more processors are individually or collectively operable to execute the code to cause the UE to:
receive the first small data transmission in accordance with a first transmit power via the first set of communication resources, the first transmit power associated with the first service; and
receive the second small data transmission in accordance with a second transmit power via the first set of communication resources, the second transmit power associated with the second service, wherein selectively decoding one of the first small data transmission or the second small data transmission is based at least in part on the first transmit power, the second transmit power, or both.

15. The UE of claim 11, wherein the first service is associated with an in-phase portion of a first signal that is modulated according to orthogonal frequency division multiplexing and the second service is associated with a quadrature phase portion of the first signal, wherein selectively decoding one of the first small data transmission or the second small data transmission comprises selectively decoding the in-phase portion of the first signal or the quadrature phase portion of the first signal.

16. The UE of claim 11, wherein selectively decoding one of the first small data transmission or the second small data transmission is based at least in part on a first spreading factor, a first spreading sequence, or a first scrambling sequence associated with the first service, a second spreading factor, a second spreading sequence, or a second scrambling sequence associated with the second service, or a combination thereof.

17. The UE of claim 11, wherein the first small data transmission is received via a first subset of symbols of a first signal and the second small data transmission is received via a second subset of symbols of the first signal, the first subset of symbols associated with the first service and the second subset of symbols associated with the second service are interleaved within the first signal, wherein selectively decoding one of the first small data transmission or the second small data transmission comprises selectively decoding the first subset of symbols of the first signal or the second subset of symbols of the first signal.

18. The UE of claim 11, wherein the one or more processors are individually or collectively further operable to execute the code to cause the UE to:
receive signaling indicative of assistance information associated with multiple access small data transmissions, the assistance information indicating a first set of multiple access parameters associated with the first service, a second set of multiple access parameters associated with the second service, or both, wherein selectively decoding one of the first small data transmission or the second small data transmission is based at least in part on the assistance information.

19. The UE of claim 18, wherein the signaling indicative of the assistance information comprises radio resource control (RRC) signaling, medium access control control element (MAC-CE) signaling, downlink control information (DCI) signaling, or a combination thereof.

20. A method for wireless communications by a user equipment (UE), comprising:
encoding a first small data transmission associated with a first service according to a first set of multiple access parameters and a second small data transmission associated with a second service according to a second set of multiple access parameters, each of the first small data transmission and the second small data transmission comprising a respective amount of data less than a threshold amount of data associated with small data transmissions;
transmitting, via a first set of communication resources, the first small data transmission associated with the first service based at least in part on the first set of multiple access parameters; and
transmitting, via the first set of communication resources, the second small data transmission associated with the second service based at least in part on the second set of multiple access parameters.
